(19) United States
(12) Patent Application Publication
(10) Pub. No.: US 2002/0023074 A1
(43) Pub. Date: Feb. 21, 2002

(54) Knowledge assembly line

(76) Inventors: Richard J. Miller, Montesano, WA (US); Brian L. Sterling, Hoquiam, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/797,193

(22) Filed: Feb. 28, 2001

Related U.S. Application Data
(60) Provisional application No. 60/185,957, filed on Feb. 29, 2000.

(51) Int. Cl. G06F 7/00

(52) U.S. Cl. 707/1; 707/104.1

(57) ABSTRACT

The Knowledge Assembly Line is a solution process for developing electronic solutions that are seamless in their format, language, font and composite graphics such that a transparent transition between a host web site and a third party vendor web site is created. The process includes gathering information, organizing information, digesting and compiling information, organizing solution groupings, designing and creating solution graphic elements, producing content and publishing solutions. One aspect of this invention is that the compilation of this process yields an individualized and unique solution that seamlessly corresponds to the look and feel of the host web site such that a customer on the host web site is transparently linked between sites. Another aspect of the method of creating a knowledge assembly line is the ability to turn around a robust knowledge base in approximately eight weeks, including the publication of the solution.

### CROSS-REFERENCE TO RELATED APPLICATION

This application claims the benefit of U.S. Provisional Patent Application No. 60/185,957, filed Feb. 29, 2000. This provisional application is incorporated herein by reference in its entirety.

### BACKGROUND OF THE IVENTION

In the past, if a web site supplier wanted to provide support services such as help solutions, marketing support, additional product information, human resources support, or the like, the supplier set up and expensive and often inefficient telephone systems with operators fielding questions. This system was not only expensive to manage, but it was inefficient. If each operator were not trained in the specifics of all operations, many questions were either rerouted or left unanswered. This yielded unsatisfied customers. Further, due to practical limitations and cost constraints, many telephone answering systems had limited hours of operation that did not included evening and weekend hours. The nature of electronic communication and data systems is such that it is available 24 hours per day, every day of the week. Customers expect that support options will similarly be available.

In yet another attempt to provide electronic service and support to their customer, web site owners have provided electronic support services developed in-house. Because the web site owners' primary business and expertise was not in this area, these solutions were expensive to develop and unworkable for the customer, again leading to frustration.

### SUMMARY OF THE INVENTION

The Knowledge Assembly Line is a solution process for developing electronic solutions that are seamless in their format, language, font and composite graphics such that a transparent transition between a host web site and a third party vendor web site is created. The process includes gathering information, organizing information, digesting and compiling information, organizing solution groupings, designing and creating solution graphic elements, producing content and publishing solutions. One aspect of this invention is that the compilation of this process yields an individualized and unique solution that seamlessly corresponds to the look and feel of the host web site such that a customer on the host web site is transparently linked between sites. Another aspect of the method of creating a knowledge assembly line is the ability to turn around a robust knowledge base in approximately eight weeks, including the publication of the solution.

### PROVISIONAL DESCRIPTION OF THE INVENTION

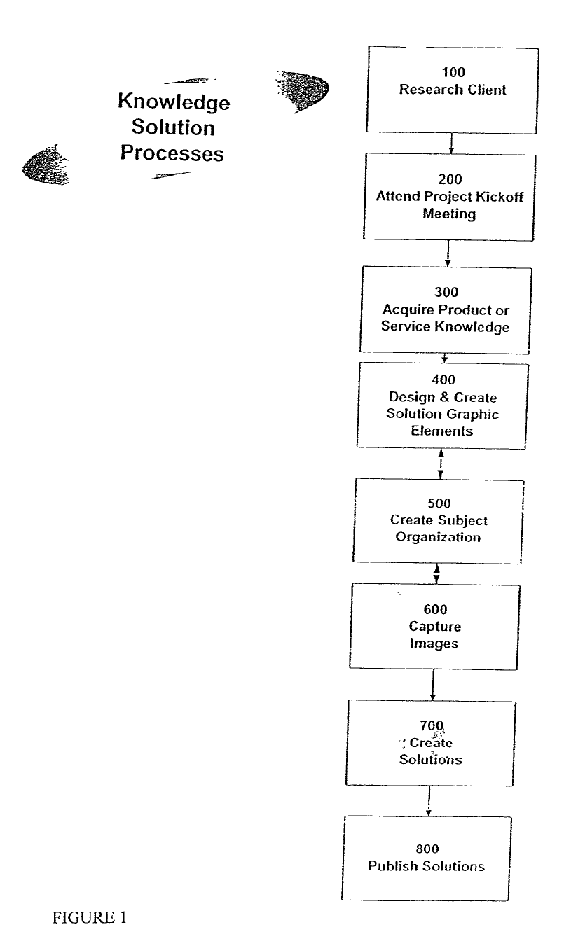

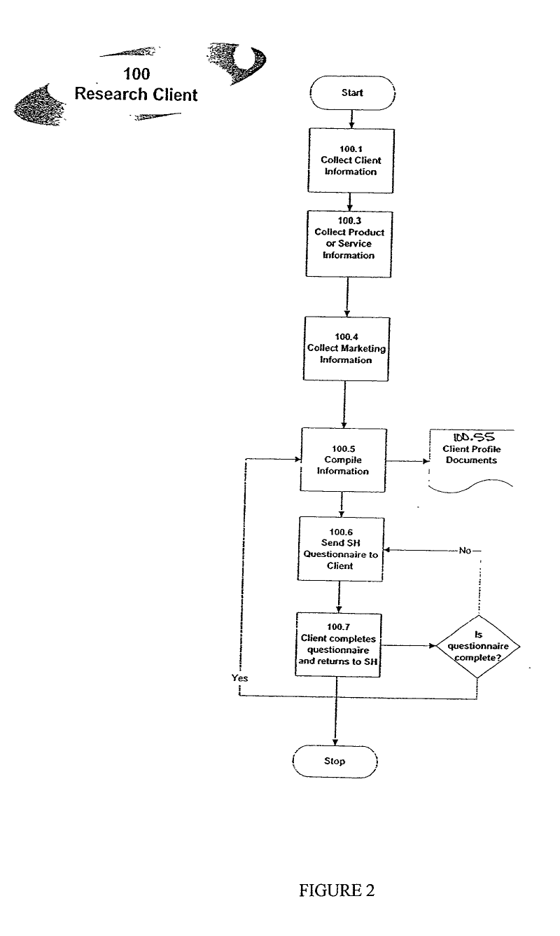

The Knowledge Solution Processes shown in FIG. 1 include the process of gathering information, organizing information, digesting information, producing content, and publishing solutions by working through various steps including researching the client, attending a project kickoff meeting acquiring product or service knowledge, design and create solution graphic elements, create subject organization capture images, create solutions and publish solutions. These steps are detailed in FIGS. 2-10 flowcharts and result in obtaining a final knowledge solution application. The targeted commercial application for this process includes integrated and seamless help solutions within a client's web site for their customers. Additional market applications include marketing support human resources support, consumer goods, internal maiket goods, internal applications to a business, and support for various existing processes.

FIG. 2, Researching the Client, includes preliminary data gathering to define a “feel” for the client's business via, for example, electronic sales data and their business web site One goal of researching the client is to understand the mindset of the particular client in order to create an individualized and unique solution. Another goal is to build a foundation for creating a seamless solution. The process of gathering information, integrating information and mirroring the web site's “look and feel” are combined to create a seamless solution. This seamless solution is a product that the customer would create themselves if they had the resources.

A Knowledge Engineer uses the client's web site(s) to collect company, client, marketing data, and product Or service information to start the Knowledge Acquisition phase of a new client implementation. This information provides background information and helps the Knowledge Engineer to get a feel for the new client and understand the chent's marketing niche.

Information is collected from a variety of sources. Information may, for example, be collected under 100.0 from client publications or brochures such as the client's web site, financial reports, business plan, or public reporting such as SEC filings. Further, as noted in 100.2 Collection of Product or Service Information includes reviewing product brochures, product advertisements, product specifications, service descriptions, related or competing product information, and market comparables. Additional information with respect to products and services include collecting a database of existing issues, problems, or questions from the client's customer. Under 100.4, information may also be collected with respect to marketing information. Marketing information may include, for example, marketing plans, marketing studies, and marketing promotional information.

Information resources include both historical information and data collection from the client as well as extensive knowledge of browser interface and modular generic models that integrate into the customer's customized knowledge base. This extensive knowledge of browser interfaces facilitates the knowledge acquisition process by helping to spot compatibility issues and troubleshooting issues.

The collection and compilation of information over time yields a knowledge base of knowledge bases. This system for creating a knowledge assembly line results in the ability to turn around a robust knowledge base including the output of a solution application in approximately eight weeks.

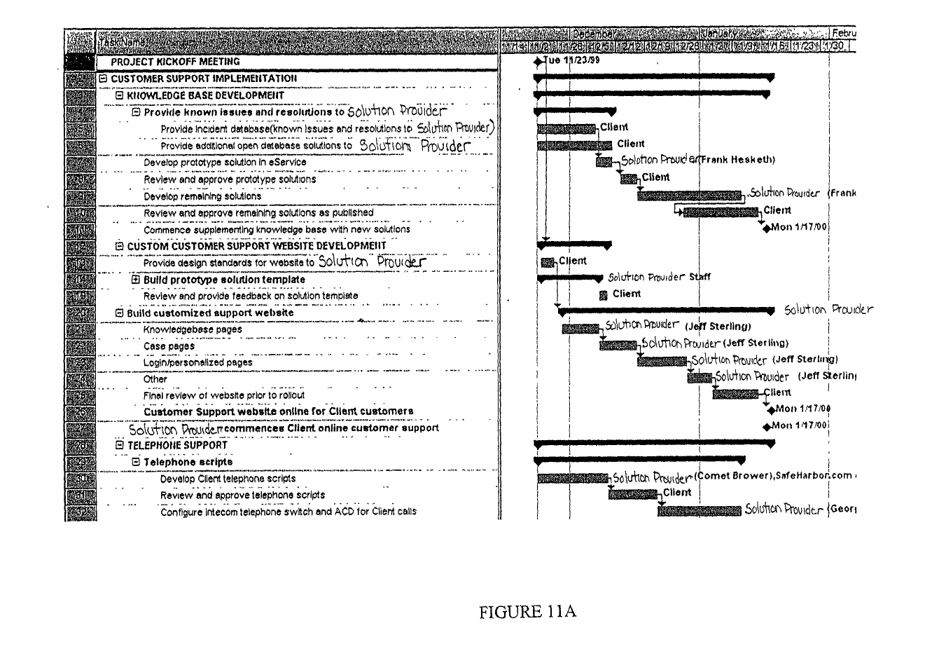

FIG. 2 further includes a compilation of the initial acquisition of knowledge in order to prepare client profile documents, 100.5, and allows customization of a questionnaire for the customer, 100.6. An example of an implementation questionnaire is shown in FIGS. 11A-D. As stated previously, information acquisition, including visiting the client's web site, collecting databases of existing outstanding issues and questions from the client's customer, obtaining information regarding the client's marketing plan, direct client response to the customized questionnaire, and obtaining a flavor and an attitude with respect to the client's business plan, allow the solution application to follow the look and feel of the client's web site.

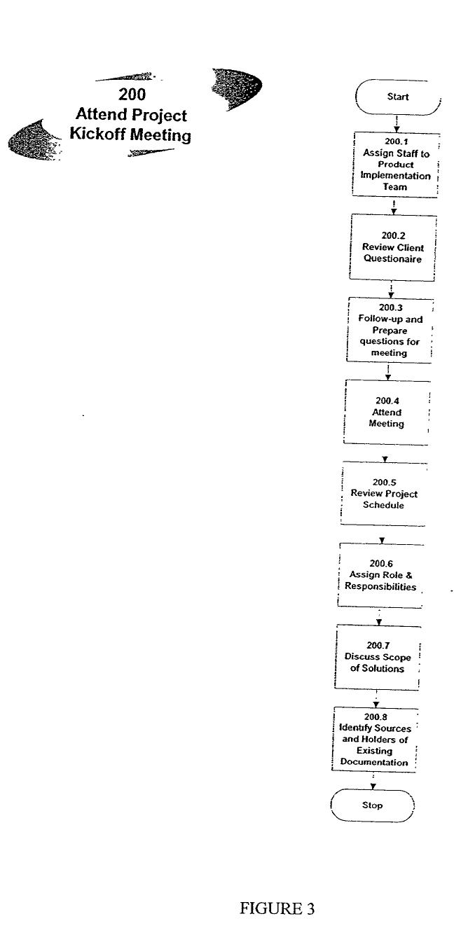

FIG. 3 outlines the Project Kickoff Meeting which allows and is part of the advance preparedness for rapidly producing a working solution set by obtaining client information in advance of preparing the solution.

The Kickoff Meeting is the first time all major players meet in person. Both the solution supplier and the client identify key roles and responsibilities. The Knowledge Engineers use this information to work expeditiously to acquire the product/service knowledge and build the solutions in a short cycle time. For example, following the flowchart outlined in FIG. 1, the turnaround time for a robust knowledge base is approximately eight weeks including the output of a solution application. Turnaround time may vary depending on the robustness of the knowledge base. During the Kickoff Meeting, the Knowledge Engineers may break into specialized meetings with the client's personnel where the received information and the questionnaire may he reviewed. Depending on the maturity of the products/service and organization of the client team, the Knowledge Engineers may discuss possible solution subjects at this meeting and get a feel for the subject hierarchy.

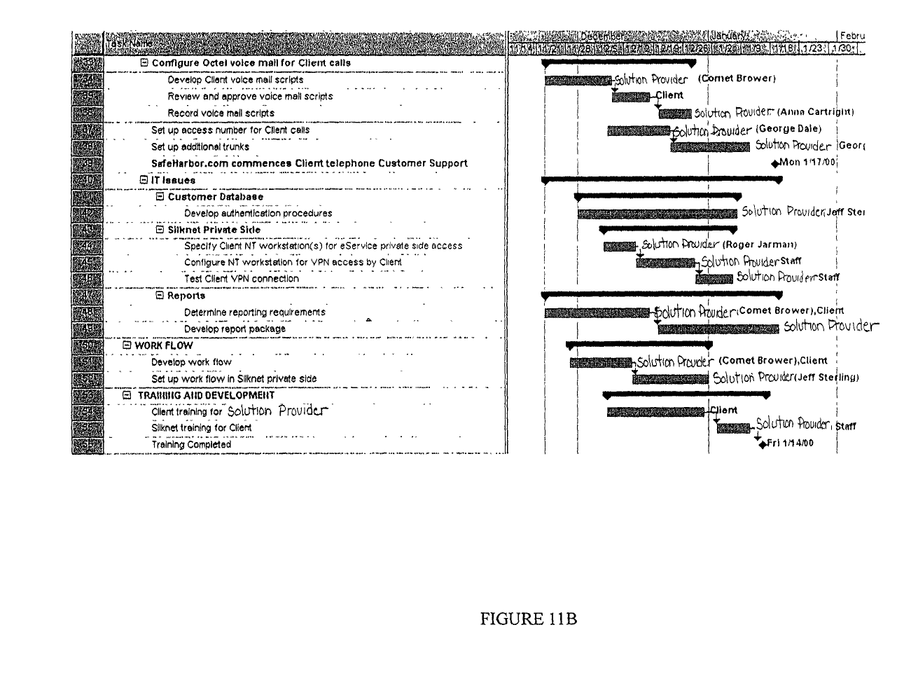

In FIG. 3, under 200.1, staff is assigned to the product implementation team with regard to relevant experience and expertise. Under 200.2, the Knowledge Engineer conducts a review of the client's questionnaire with the client in order that under 200.3, follow-up questions can be prepared for the meeting. Under 200.4, all major players from both the solution supplier and the client attend a meeting to review the project schedule, 200.5, and assign roles and responsibilities to the key players, 200.6. An exemplary Gantt chart schedule is included in FIGS. 12A and 12B showing a hypothetical assignment of roles to both the solution supplier's staff as well as the client's staff on a critical path schedule. Further discussion under 200.7 of the scope of the solutions and under 200.8 identifying sources and holders of existing documentation for further information gathering purposes. In many cases, the client will be asked to give a demonstration beyond the marketing demonstration that is typically given. For example, a demonstration targeted to a customer to further gain knowledge regarding the client's objective. At this point a formal basis of knowledge base is being compiled from both the questionnaire, notes from the presentation, and acquisition of knowledge from both the client and the end user (customer). Additionally, follow-up site visits and/or conferences may be scheduled. The project kickoff meeting also includes face time between the key players in order to personalize the process so that both parties can understand a full understanding of the assumptions, the scope, and the conflicts.

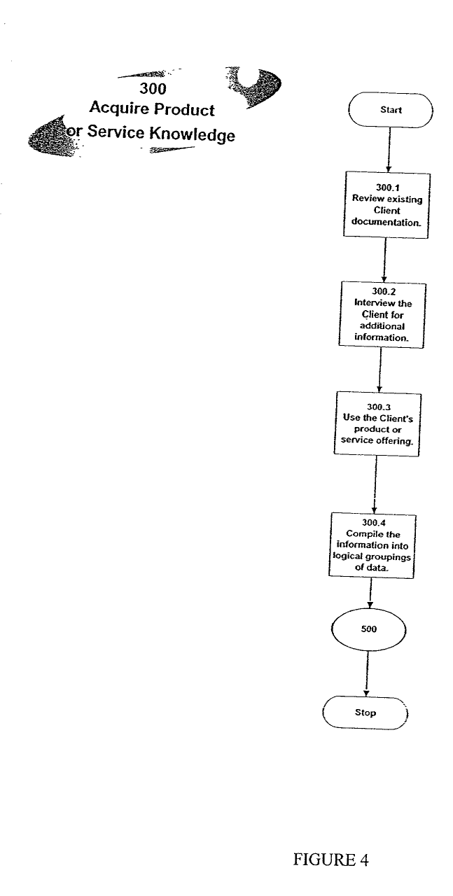

FIG. 4, Acquire Product or Service Knowledge, is a more specialized information gathering step. This is a time to gather all non-web-based marketing information, training manuals, specification user guides, marketing materials, beta testing logs, FAQs or technical support manuals. It is not necessary that the whole team participate in each aspect of this process, but rather a more specialized approach can be used. Often this includes going back to the client's site for more information, follow-up and general access to the client's non-web-based information.

In FIG. 4 under 300.1, the Knowledge Engineer reviews any existing written documentation. This includes user guides, specifications, customer support knowledge bases, help files, white papers, marketing materials, beta testing logs, FAQs, or technical support manuals. Under 300.2, the Knowledge Engineer interviews the client (support manager, support personnel, developers, sales and marketing people) for any additional or missing information about the product or service. Under 300.3, the Knowledge Engineer uses the client's product or service offering, including installation, use and abuse, to understand the functionality from the user's perspective. During the research and use phase under 300.4 the Knowledge Engineer compiles many possible solution issues.

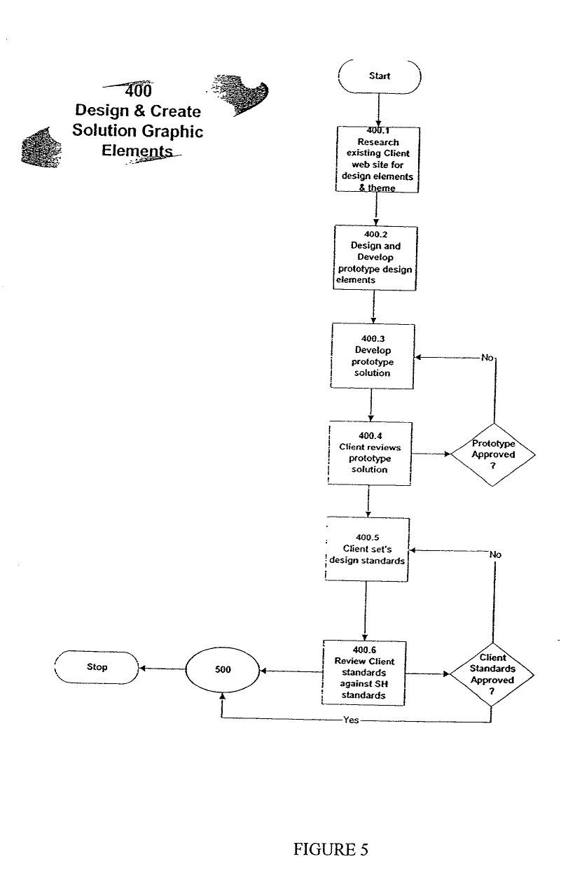

FIG. 5, Design and Create Solution Graphic Elements, continues the process of gathering information about the product that will be supported by organizing and digesting the information, producing and developing the content of the knowledge base, illuminating that content of the knowledge base, and publishing/delivering that information to the reader with a specific goal of developing a customized look and feel solution prototype. Under 400.1, research and mapping of the existing client web site for both design elements and theme are completed. Both the client's web site and/or provided interface are reviewed and analyzed for design elements and theme. These include color, fonts, theme, and graphical elements. These design elements are then incorporated into the solution provider's solutions in order to create a transparency from the clients source site and the solution provider's support site.

Under 400.2, design and development of a prototype solution design element including graphic look and feel of the client's web site is developed. Specifically, the Knowledge Engineer creates the design elements. These designs elements include for example, the discrete numbers, lines, ovals, and other design elements that will be used in the graphical solution.

Under 400.3 the Knowledge Engineer creates a draft prototype solution incorporating the design elements with some actual screen shots from the client's product. This is the first time the design elements are included with the actual product application windows. Under 400.4, the Knowledge Engineer sends the prototype solution to the client for review. The prototype solution may include one or many solution sets to give a client a feel for the overall knowledge database. The client either approves the prototype to allow creation of a more global solution set, or requests redesign work until the final prototype solution is created and approved. Under 400.5, the client sets the design standards tied to the approval of the prototype. These design standards are more specific for application to the final product and may include, for example, color, theme, font and graphical elements. Under 400.6, the client's standards are compared to the solution provider's standards for consistency. At this time, the client's standards are approved or discussed with the client.

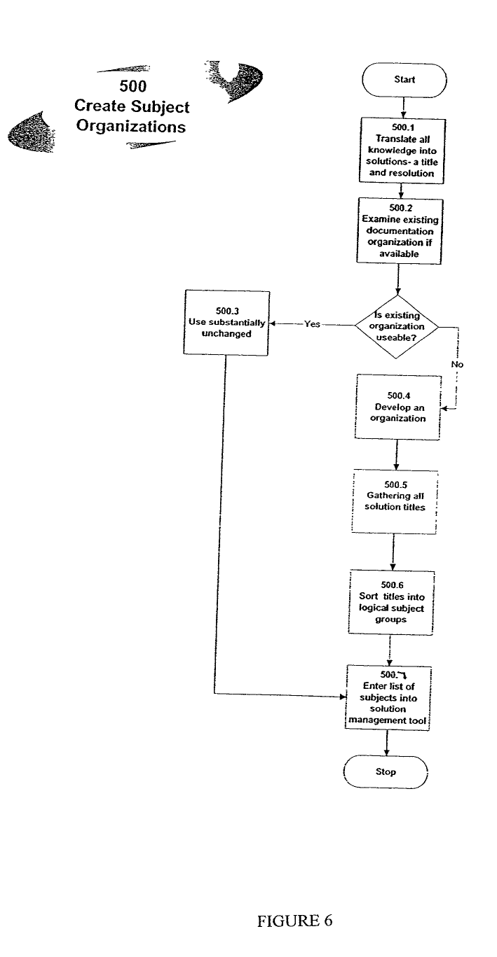

FIG. 6, Create Subject Organizations, the knowledge engineer takes all acquired knowledge and categorizes and breaks them down into solutions at the title level 500.1, similar to an outline, to be taken to the software level. The organization of this outline is typically from the end user's point of view, as opposed to content that is strictly client oriented. The Knowledge Engineer examines existing documentation organization 500.2, if available, to determine if the existing organization of the data is useable. If the organization is useable, 500.3, then the Knowledge Engineer proceeds to the step of creating a list of subjects for the solution management tool, 500.7. If the organization is not useable or complete, then the Knowledge Engineer develops a useable organization, 500.4. Under 500.5, solution titles are then gathered into logical groupings and under 500.6, in accordance with existing documentation organization, sorted to obtain a solution management tool. Under 500.7, the Knowledge Engineer enters a list of subjects into the solution management tool.

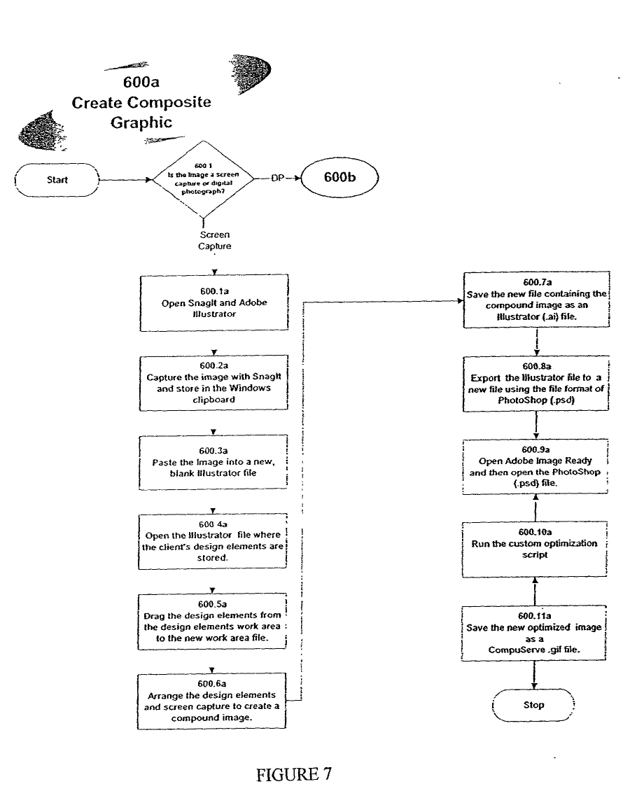

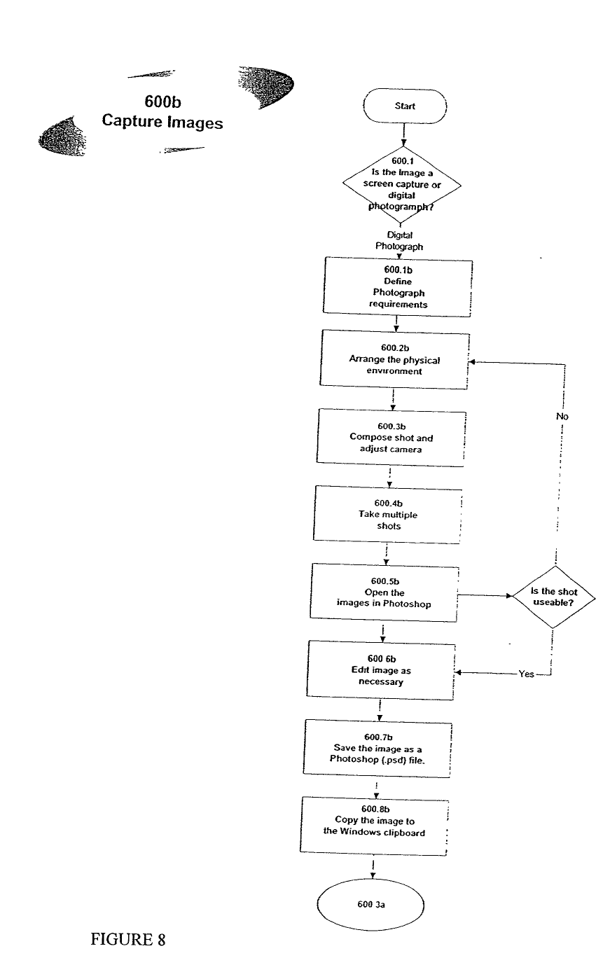

FIGS. 7 and 8 outline one exemplary process that may be used by the knowledge engineer creating a composite graphic or capturing an image. FIG. 7 pertains to software applications including flowcharts or other similar non-tangible items, whereas FIG. 8 pertains to a tangible application such as a hardware solution. The graphic composite or captured image populates the solution set and is used as a tool in the actual creation of the solutions and their visual components.

In FIG. 7, under 600.1, if the image is a screen capture or a digital photograph, then a design program such as Snagit and Adobe Illustrator is opened, 600.1a. The Knowledge Engineer captures the image with a software program such as Snagit and stores it in the operating system, for example, Windows, clipboard, 600.2a. The Knowledge Engineer pastes the image into a new blank illustrator file, 600.3a. Under 600.4a, a file that stores all the custom created design elements is created. These include the numbers, lines, and other shapes. Under 600.5a, the design elements are moved from the design elements work area to the new work area file. In 600.6a, the first step of building a graphic solution is taken. Each screen capture and related design elements are created as separate files. Under 600.7a, this file becomes the editable source file and is named and stored meeting Knowledge Engineering standards. Under 600.8a, the file created in 600.7a is used to then create another file that is created using Illustrator's export function and saved as a file such as a PhotoShop file with the extension of .psd. Under 600.10, a highly compressed image is created with an optimization script. Under 600.11a, the new compressed image is then saved as a gif. The Knowledge Solution is then composed of a plurality of graphics.

FIG. 8 outlines a solution with respect to a hardware solution. Images are captured via digital photography or the like and these images are used in the solution set. If it is determined that the image is a digital photograph and not a screen capture, 600.1, then the following is an exemplary process that may be used by the Knowledge Engineer when creating a composite graphic or capturing an image. Under 600.1b, the Knowledge Engineer defines the photograph requirements, and then arranges the physical environment, 600.2b. The Knowledge Engineer composes the digital photographic shot and adjusts the camera under 600.3b. For practical reasons, it is recommended that the Knowledge Engineer takes multiple photographic shots, 600.4b, the Knowledge Engineer then opens the images in a software program that is capable of manipulating the images such as Photoshop, 600.5b. If the shot is not useable, then the Knowledge Engineer goes back to 600.2b and produces a new digital photograph. Once the image is viewable via a software program on a computer screen, the Knowledge Engineer may make any necessary edits, 600.6b. The Knowledge Engineer then saves the image as a .psd file or any other graphic file, 600.7b. The Knowledge Engineer then can copy the image to a clipboard in the operating system, such as Windows, 600.8b. Once the image is in this format, the Knowledge Engineer can proceed with the process illustrated in FIG. 6 beginning at step 600.3a, to complete the creation of a composite graphic.

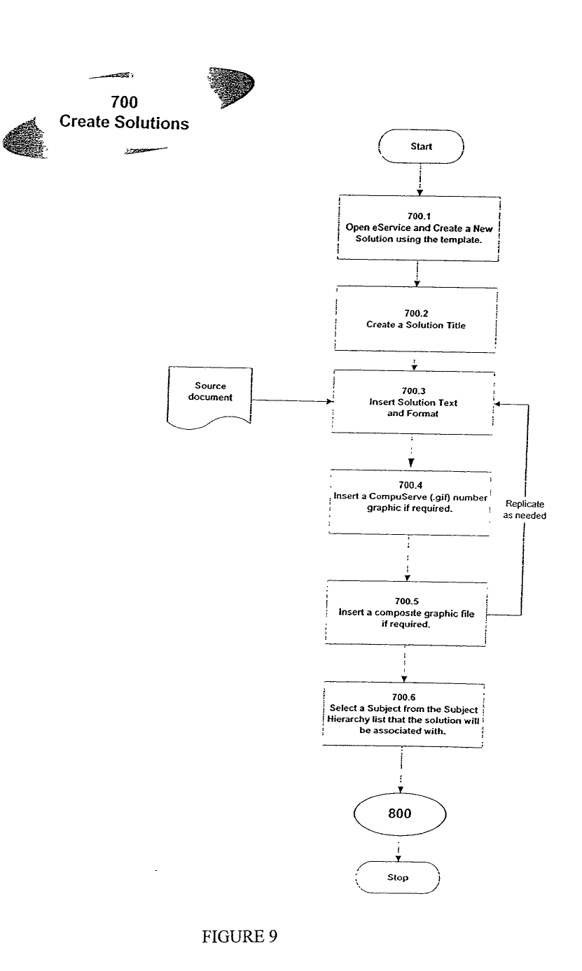

FIG. 9, Creating the Solutions, the outline of solution titles are then integrated with the database of composite graphic or captured images to create solutions usable by the client. The solution titles should meet the Knowledge Engineering style guide standards, for example, the solution titles should be in the first person interrogative, and should not exceed 51 characters, 700.2. Further, plain text can be copied into a software solution editor such as eService and formatted as appropriate or hand entered directly into the editor, 700.3. Numbers are used in the solution for clarity if the solution is composed of steps that may or may not be illuminated in the composite graphic, 700.4. The Knowledge Engineer may also insert a composite graphic file, if required, 700.5. These steps of formatting an integrating the text with the numbers and the composite graphic are replicated as needed. A solution is then associated with a subject in order to use a dynamic linking functionality, 700.6. Solutions may still be located by searching. The solution subjects are the organizational structure of the knowledge base and delivery. Dynamic linking functionality is akin to chapter headings and is system generated.

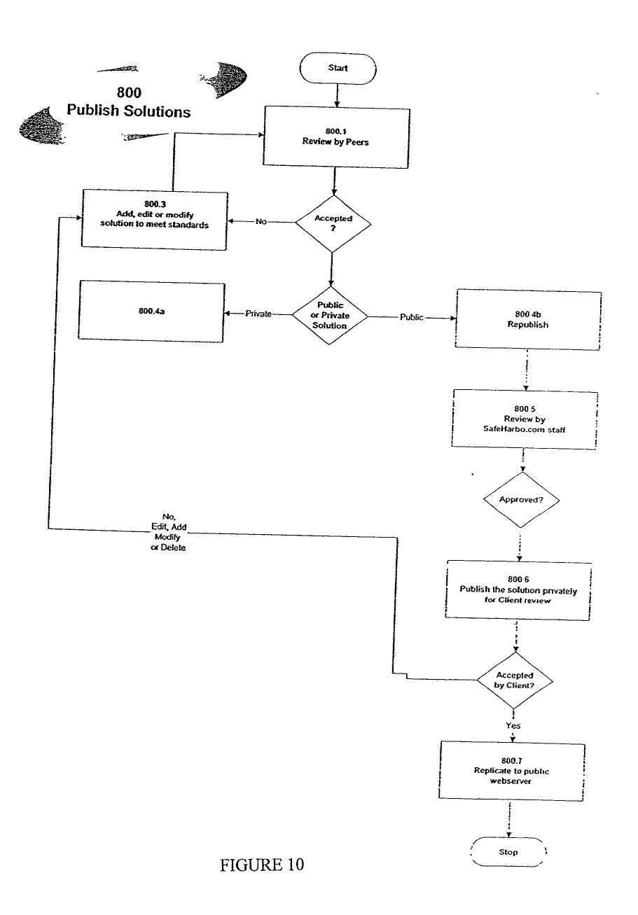

FIG. 10, Publish Solutions, the solution is published after going through quality analysis review cycles, for example, the three separate quality analysis review cycles shown in the exemplary example. As shown, initially there is a peer review by independent knowledge engineers, 800.1. A further review is conducted by the web development group and finally by the contact center operations, 800.2. These reviews not only review design and style guide standards but also review for functionality and usability. At this point, if accepted, the solution database is then sent to the client for approval and review, 800.6. Once the solution is approved by the client, the solution is replicated to the public web server, 800.7.

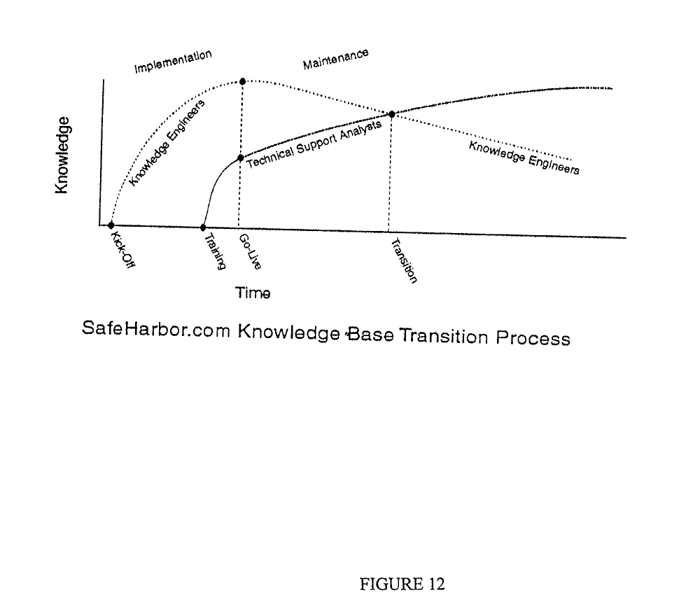

Overall, the acquisition of knowledge allows for the initial development of the process, which proceeds into an evolution or an iteration including feedback from the client and the client's customers to refine the look and feel of the solutions and create a knowledge solution product. This knowledge solution is consistent in writing style, in text, and in look and feel with the parent web site so that the client's customer does not know they have left the original web site. In fact, screen toolbars from the parent web site are used in the solution database to create consistency. This approach lends itself to an efficient solution system that is both approachable, easy to understand, and in essence, a cookbook approach that allows the newest user to master. This approach is cost efficient and further allows customers to get to their own solution without actual human intervention. A graph depiction of the Knowledge Base Transition Process is illustrated in FIG. 13.

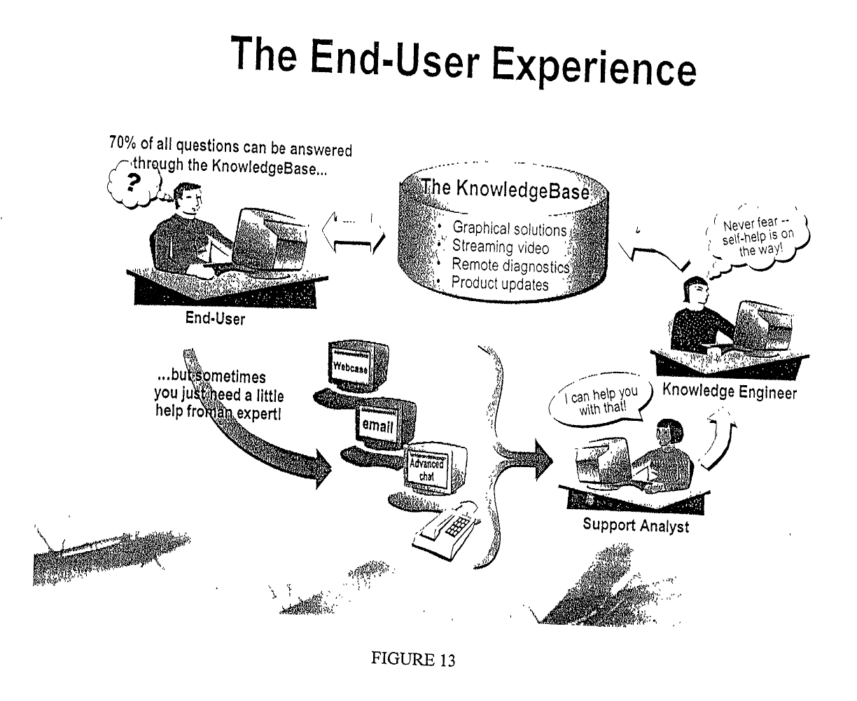

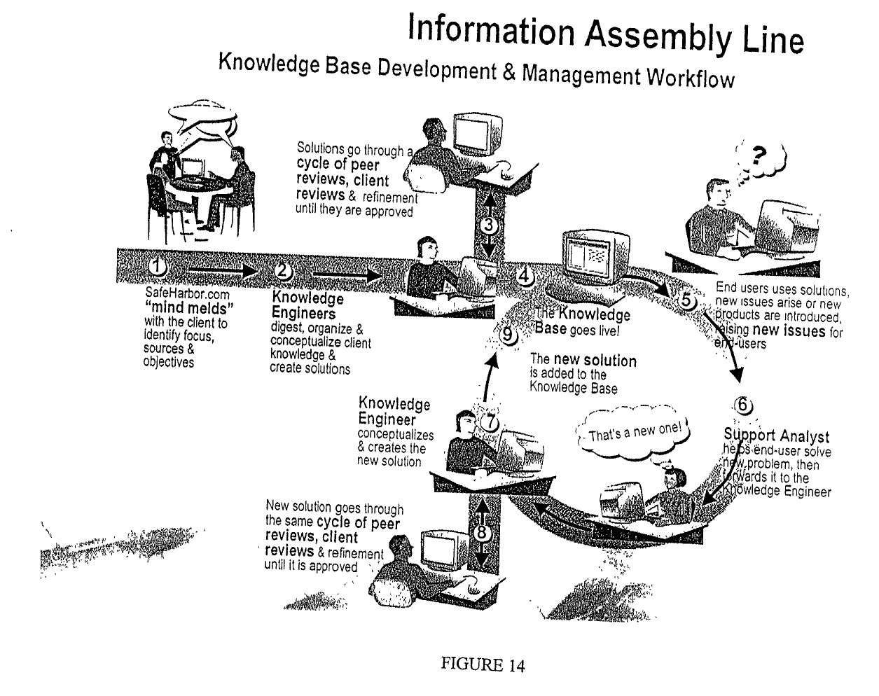

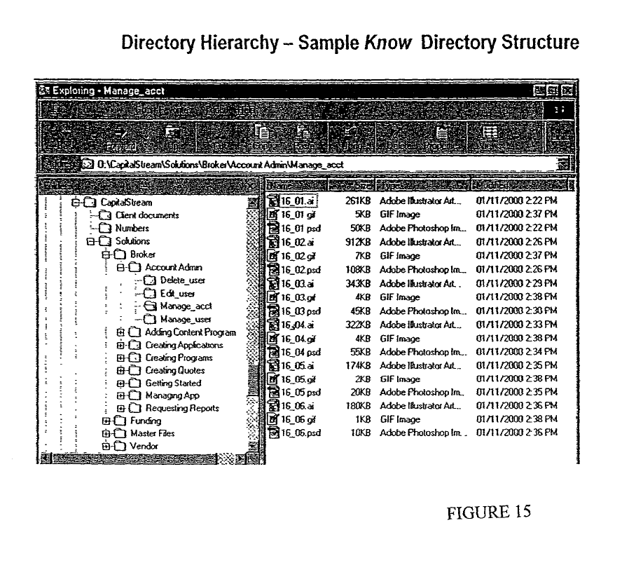

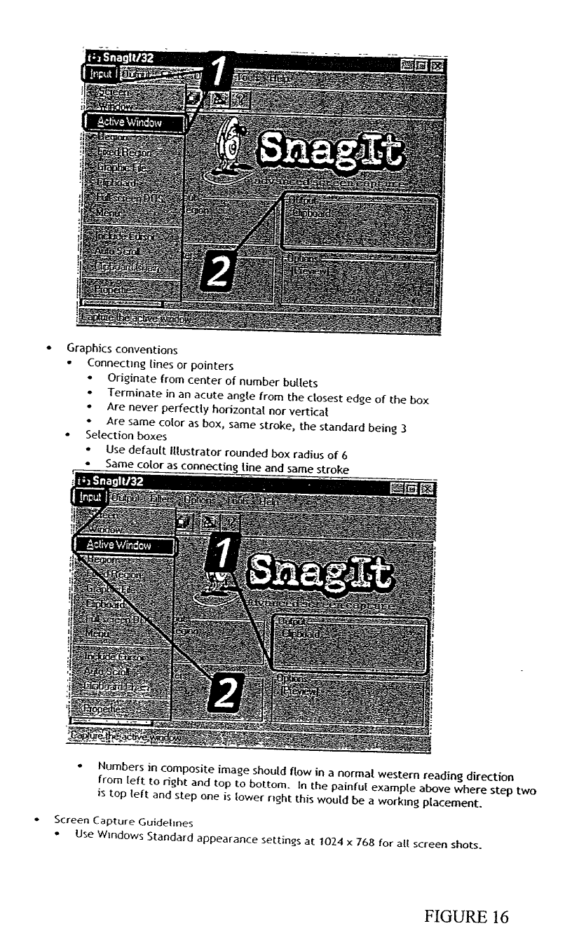

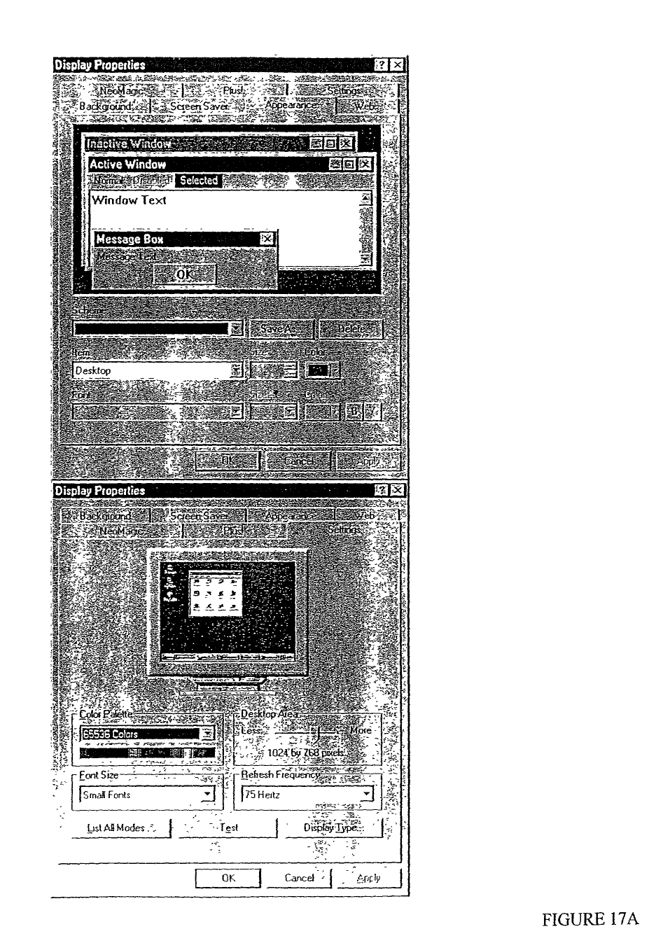

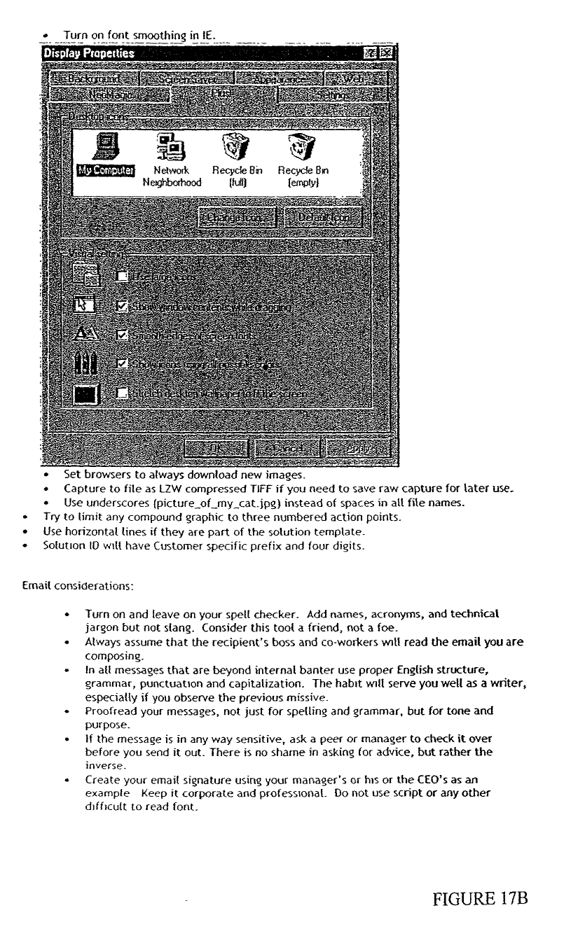

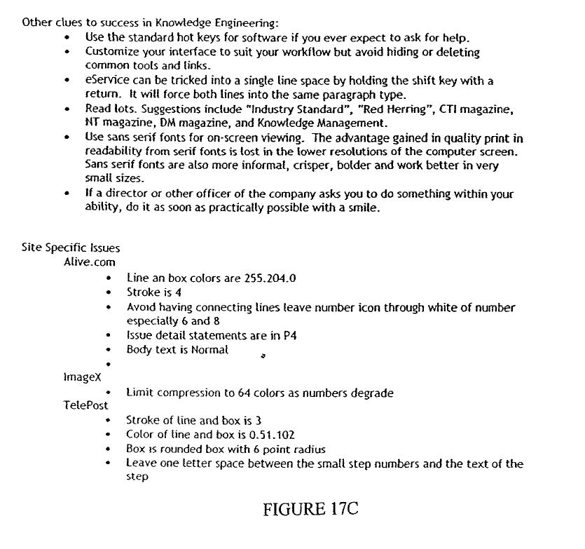

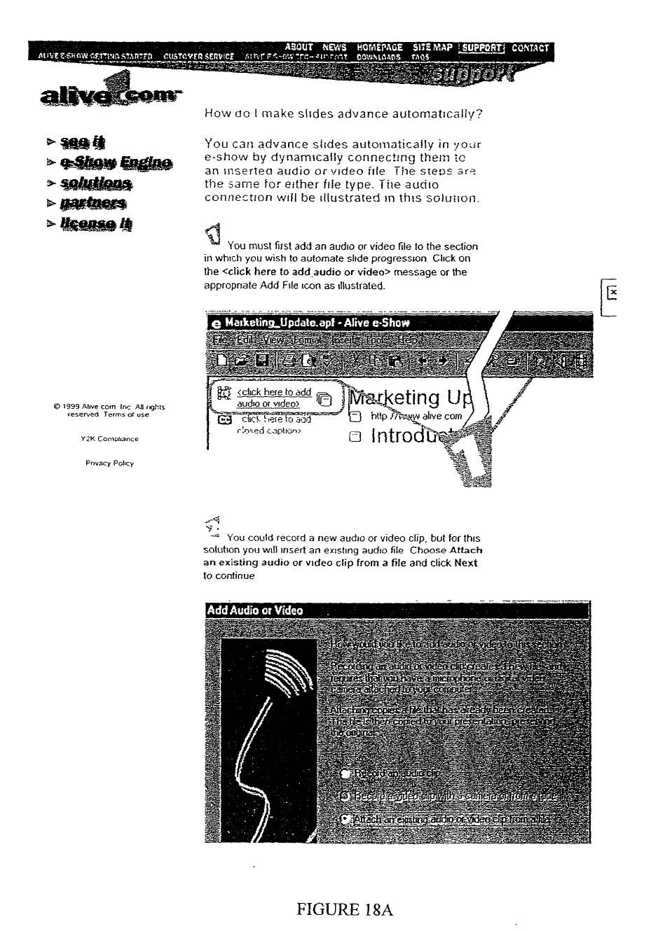

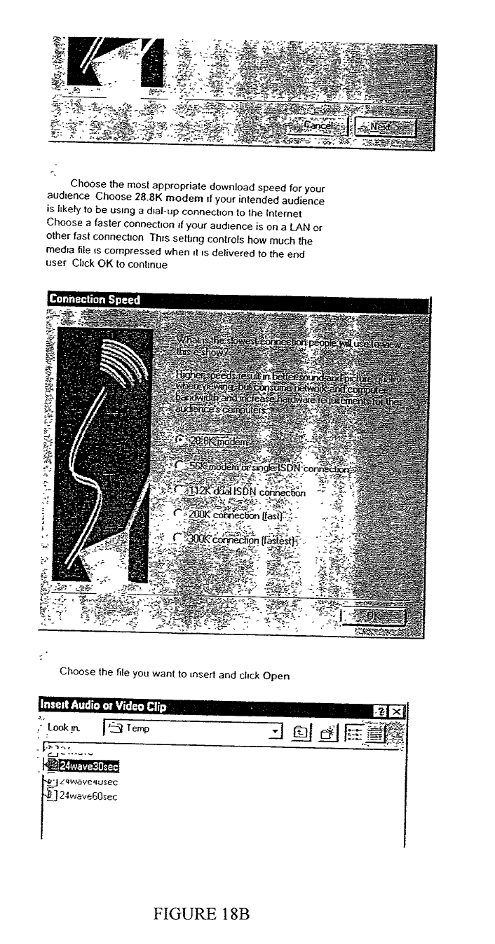

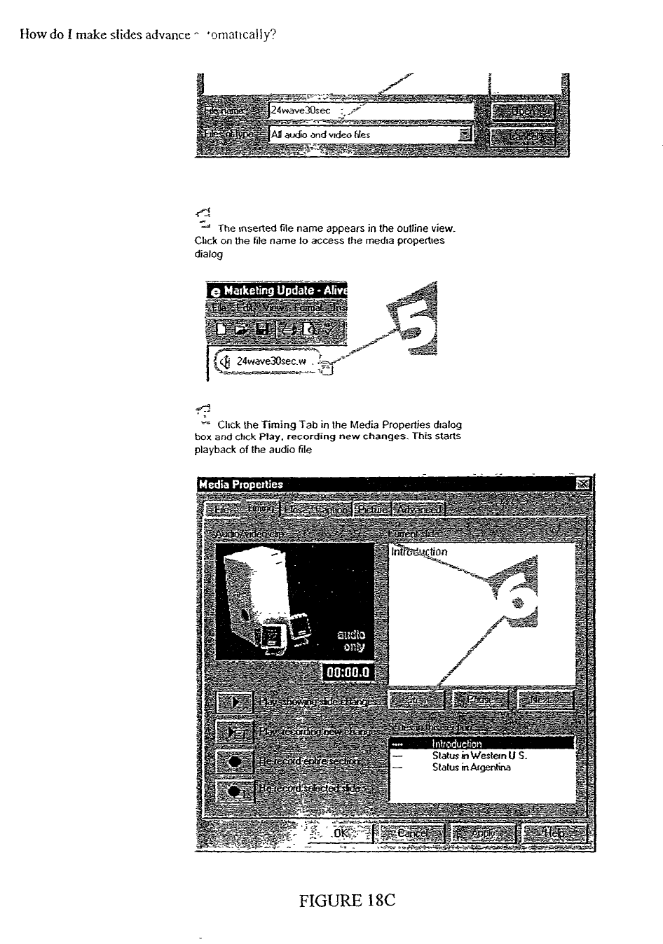

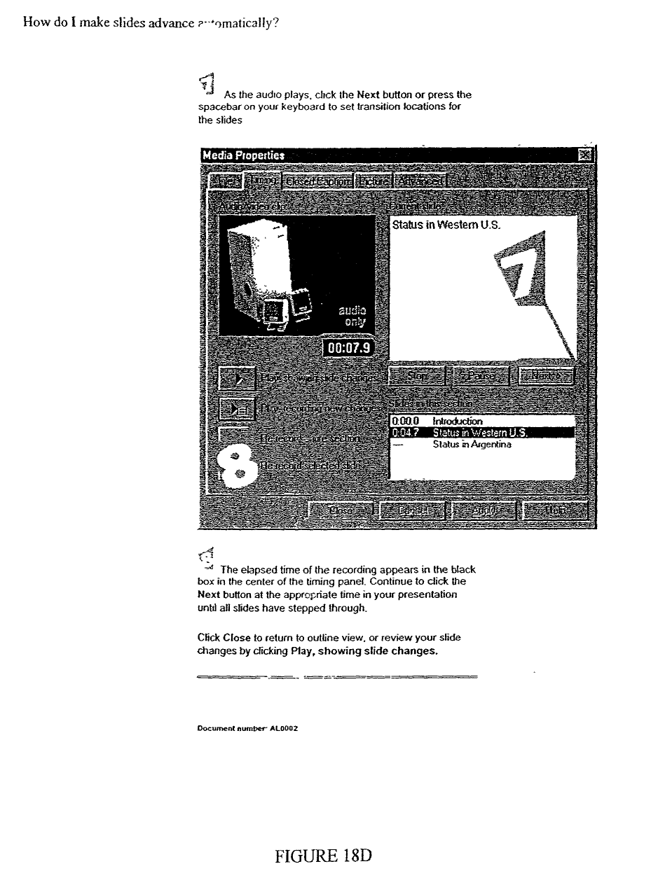

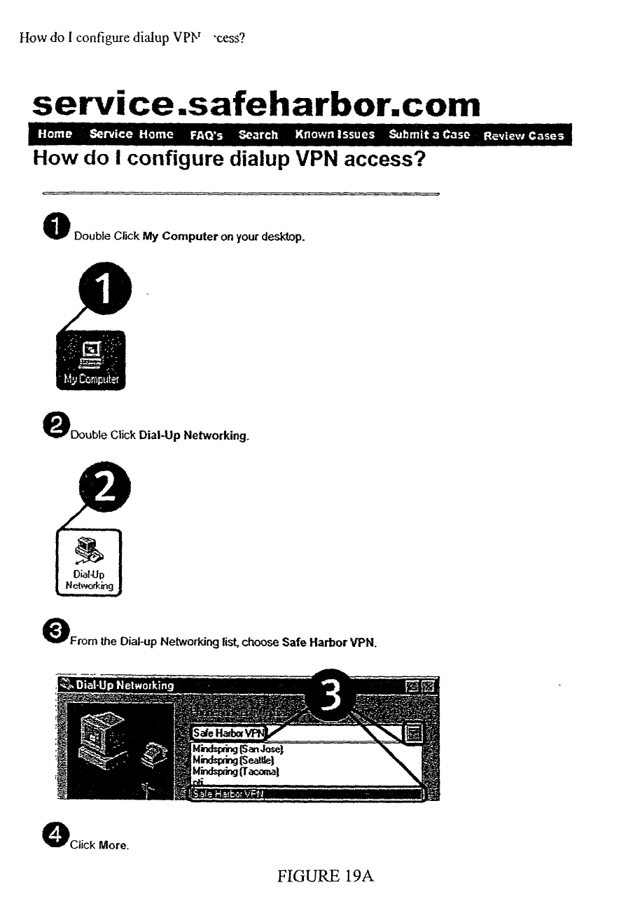

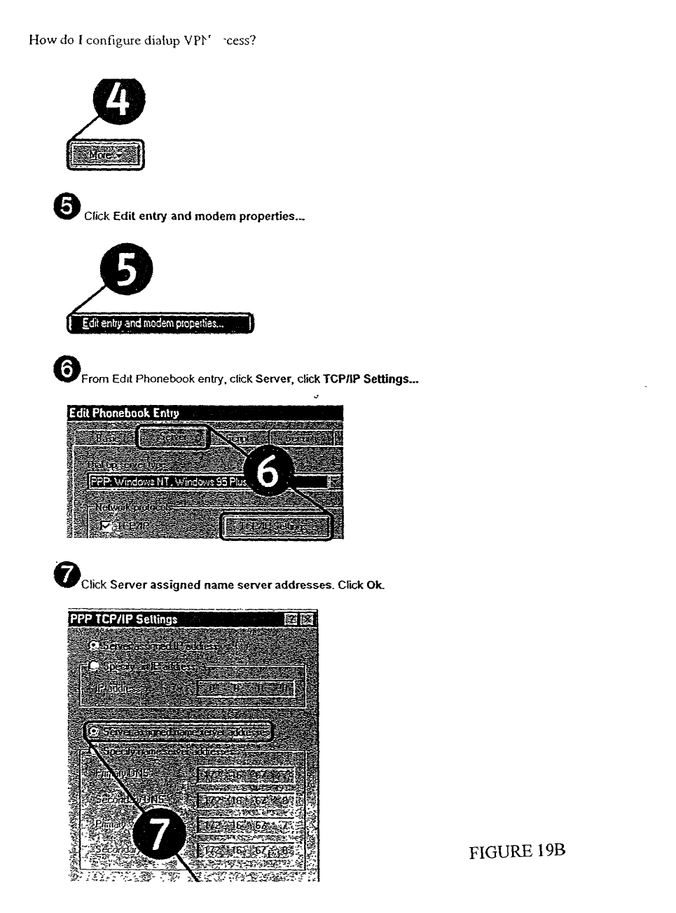

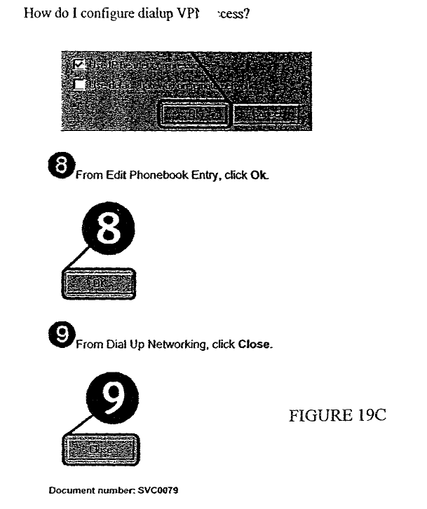

A graphical flow of the end user experience is depicted in FIG. 14. A graphical flow of the Information Assembly Line is depicted in FIG. 15. FIGS. 16-21 illustrate various flow sheets for the steps in the Knowledge Assembly Line FIGS. 22-27 include exemplary screen shots and flow sheets of actual solutions.

From the foregoing it will be appreciated that, although specific embodiments of the invention have been described herein for purposes of illustration, various modifications may be made without deviating from the spirit and scope of the invention. Accordingly, the invention is not limited.

1. A knowledge assembly line for researching, collecting, and disseminating data to provide seamless support information to electronic customers, comprising:
client information;
product and service information;
marketing information; and
client questionnaire answers, wherein the client information, product and service information, marketing information and questionnaire answers are collected, compiled and disseminated to create a solution to be integrated into the client system.

2. A knowledge assembly line for researching, collecting, and disseminating data to provide seamless support information to electronic customers, comprising:
client research including client information, product or service information or client questionnaire answers;
product or service knowledge including user guides, specifications, customer support knowledge bases, help files, white papers, marketing materials, beta testing logs, FAQs or technical support manuals;
a solution graphic element that seamlessly integrates with the client's format, font and image;
a solution subject outline wherein the solution subject outline categorizes and organizes the solutions;
a composite graphic including a screen capture or digital photograph, a seamless electronic solution associated with components of the client's web site.

3. A computer-implemented system for transparently providing electronic support via an independent support provider web site through links provided on a host web site, comprising a host web site accessible via a computer networking system;
client research including client information, product or service information or client questionnaire answers;
product or service knowledge including user guides, specifications, customer support knowledge bases, help files, white papers, marketing materials, beta testing logs, FAQs or technical support manuals;
a solution graphic element that seamlessly integrates with the client's format, font and image;
a solution subject outline wherein the solution subject outline categorizes and organizes the solutions;
a composite graphic including a screen capture or digital photograph, a seamless electronic solution associated with components of the client's web site;
a support service web site independent of the host web site, the support service web site accessible via the computer networking system, a link on the host web page connecting the host web site to the support service web site;
at least one of the support service web sites accessible through the link;
relevant support information provided on the support service web site, the relevant support information presented in a consistent format to the host web page as defined by the host web page format, font, language, and like images.

4. A method in a computer system network environment for providing a knowledge assembly line to create electronic solutions to vendor customers via a third party support service provider from a host web page, the support information provided transparently with respect to format, style, font, and graphics, such that a consistent web page format of the host site is maintained, the method comprising the steps of:
researching the client;
attending a project lickoff meeting;
acquiring product or service knowledge;
designing and creating solution graphic elements;
creating subject organization, capturing images and creating composite graphics with the images;
creating solutions; and
publishing solutions such that the published solutions are linked electronically from the third party support service provider to a host web page.
